(19) United States
(12) Patent Application Publication
(10) Pub. No.: US 2006/0049769 A1
(43) Pub. Date: Mar. 9, 2006

(54) Plasma display apparatus

(76) Inventor: Woong Kee Min, Seoul (KR)

Correspondence Address: MCKENNA LONG & ALDRIDGE LLP;Song K. Jung, 1900 K Street, N.W., Washington, DC, 20006, US

(21) Appl. No.: 11/219,864

(22) Filed: Sep. 7, 2005

(30) Foreign Application Priority Data
Sep. 7, 2004 (KR) 10-2004-0071476

(51) Int. Cl. G09G 3/10

(52) U.S. Cl. 315/169.3

(57) ABSTRACT

The present invention relates to a plasma display apparatus in which the manufacturing cost due to driving boards and the area occupied by the driving boards can be reduced. The plasma display apparatus according to the present invention includes a glass substrate having scan electrodes and sustain electrodes formed therein, an integrated electrode driving unit for generating a first driving pulse and a second driving pulse to drive the scan electrodes and the sustain electrodes, and an electrode pad formed at one side of the glass substrate, for applying the first driving pulse and the second driving pulse to the scan electrodes and the sustain electrodes, respectively. In the plasma display apparatus according to the present invention, driving pulses are applied to scan electrodes and sustain electrodes through electrode pads formed at one side. Therefore, the manufacturing cost and the area of driving boards can be reduced.

### CROSS-REFERENCES TO RELATED APPLICATIONS

This Nonprovisional application claims priority under 35 U.S.C. § 119(a) on Patent Application No. 2004-071476 filed in Korea on Sep. 7, 2004 the entire contents of which are hereby incorporated by reference.

### BACKGROUND OF THE INVENTION

1. Field of the Invention

The present invention relates to a plasma display apparatus, and more particularly, to a plasma display apparatus including electrodes.

2. Background of the Related Art

Generally, a plasma display apparatus includes an upper substrate and a lower substrate. A distance between the upper substrate and the lower substrate is sustained by barrier ribs. The barrier ribs form a unit cell. Each cell is filled with a main discharge gas such as neon (Ne), helium (He) or a mixed gas Ne+He of Ne and He, and an inert gas containing a small amount of xenon.

If a high frequency voltage is applied, the inert gas generates vacuum ultraviolet, and light-emits phosphors, implementing images. The panel of this plasma display apparatus is thin and light, and has thus been in the spotlight as next-generation display devices.

FIG. 1 shows the panel structure of a general plasma display apparatus. As shown in FIG. 1, the panel of the general plasma display apparatus includes an upper substrate 100 on which images are displayed and a lower substrate 1101.

Scan electrodes 101 and sustain electrodes 102 are formed in the upper substrate 100. Each of the scan electrodes 101 and each of the sustain electrodes 102 include a transparent electrode a made of a transparent ITO material, and a bus electrode b made of a metal material. A dielectric layer 103 covers the scan electrodes 101 and the sustain electrodes 102, limits the discharge current and provides insulation among the electrodes. A protection layer 104 is formed on a top surface of the dielectric layer 103 by depositing magnesium oxide (MgO), and it serves to protect electrodes and emit secondary electrons.

Barrier ribs 111 for forming discharge cells are formed on the lower substrate 1101. Furthermore, a number of address electrodes 112 is disposed parallel to the barrier ribs 111. R, G and B phosphors 113 that emit a visible ray are coated between the barrier ribs 111 and the barrier ribs 111. A white dielectric layer 114 protects the address electrodes 112 and reflects a visible ray emitted from the phosphors 113 to the upper substrate 100.

FIG. 2 shows a conventional plasma display apparatus. As shown in FIG. 2, the conventional plasma display apparatus includes a plasma display panel 20, a data driving unit 30, a scan driving unit 40 and a sustain driving unit 50.

The plasma display panel 20 includes address electrodes X1 to Xm, scan electrodes Y1 to Yn and sustain electrodes Z1 to Zn. The address electrodes are arranged from X1 to Xn perpendicularly. The scan electrodes are arranged on one side of the plasma display panel 20 from Y1 to Yn laterally. The sustain electrode are sequentially arranged on an opposite side to the one side from Z1 to Zn.

The scan driving unit 30 applies a ramp pulse for initializing a charge state within a cell, a scan pulse for an address discharge, and a sustain pulse for sustaining discharging to the scan electrodes Y1 to Yn.

The data driving unit 40 applies an address pulse to the address electrodes X1 to Xm in synchronization with the scan pulse applied by the scan driving unit 40.

The sustain driving unit 50 applies a sustain pulse to the sustain electrodes Z1 to Zn alternately with the sustain pulse applied by the scan driving unit 30.

At this time, electrode pads 35, 55 connect the scan driving unit 30 and the scan electrodes Y1 to Yn, and the sustain driving unit 50 and the sustain electrodes Z1 to Zn.

According to the structure of this general plasma display apparatus, the application direction of the driving pulse applied to the scan electrodes Y1 to Yn and the application direction of the driving pulse applied to the sustain electrodes Z1 to Zn are opposite to each other. For example, the scan driving unit 30 applies the driving pulse to the scan electrodes Y1 to Yn from the left side of the plasma display panel 20. The sustain driving unit 50 applies the driving pulse to the sustain electrodes Z1 to Zn from the right side of the plasma display panel 20. Accordingly, the electrode pads 35, 55 are formed at both sides of the plasma display panel 20.

The scan driving unit 30, the data driving unit 40 and the sustain driving unit 50 are implemented in the form of a driving board. Each of the driving boards is formed on a frame attached to a rear surface of the plasma display panel.

FIG. 3 shows an exemplary arrangement of each driving board attached on a frame of the conventional plasma display apparatus.

As shown in FIG. 3, a scan driving board 60, a data driving board 70 and a sustain driving board 80 are attached on a frame 90. The frame 90 supports the plasma display panel 20 and radiates heat generated from the plasma display panel 20 to the outside.

The scan driving board 60 is attached to one side of the frame 90 and is electrically connected to the scan electrodes formed on one side of the plasma display panel 20. The sustain driving board 80 is attached to the other side of the frame 90, which is opposite to the one side, and is electrically connected to the sustain electrodes formed on the other side of the plasma display panel 20.

This conventional plasma display apparatus must have two driving boards. This raises the manufacturing cost. There is also a problem in that the area occupied by the driving boards is increased due to the two driving boards.

FIG. 4 shows another conventional plasma display apparatus. As shown in FIG. 4, another conventional plasma display apparatus includes a plasma display panel 20, a data driving unit 30 and an integrated driving unit 100.

The plasma display panel 20 includes address electrodes X1 to Xm, scan electrodes Y1 to Yn and sustain electrodes Z1 to Zn. The address electrodes are arranged from X1 to Xn perpendicularly. The scan electrodes are arranged on one side of the plasma display panel 20 from Y1 to Yn laterally. The sustain electrode are sequentially arranged on an opposite side to the one side from Z1 to Zn.

The integrated driving unit 100 applies a ramp pulse for initializing a charge state within a cell, a scan pulse for an address discharge, and a sustain pulse for sustaining discharging to the scan electrodes Y1 to Yn. It also applies a sustain pulse, which is alternated with the sustain pulse applied to the scan electrodes Y1 to Yn, to the sustain electrodes Z1 to Zn.

The data driving unit 40 applies an address pulse to the address electrodes X1 to Xm in synchronization with the scan pulse applied by the scan driving unit 40.

At this time, electrode pads 35, 55 connect the integrated driving unit 100, and the scan electrodes Y1 to Yn and the sustain electrodes Z1 to Zn.

According to the structure of this general plasma display apparatus, the application direction of the driving pulse applied to the scan electrodes Y1 to Yn and the application direction of the driving pulse applied to the sustain electrodes Z1 to Zn are opposite to each other. Accordingly, the electrode pads 35, 55 are formed at both sides of the plasma display panel 20.

The integrated driving unit 100 and the data driving unit 40 are implemented in the form of a driving board. Each driving board is formed on the frame attached on a rear surface of the plasma display panel.

FIG. 5 shows another exemplary arrangement of each driving board attached on a frame of the conventional plasma display apparatus.

As shown in FIG. 5, an integrated driving board 1110 and a data driving board 70 are attached on the frame 90. The integrated driving board 100 is one in number, in which the scan driving unit 30 and the sustain driving unit 50 shown in FIG. 2 are implemented on one board. Accordingly, the integrated driving board 100 is attached to one side of the frame 90. It is electrically connected to scan electrodes formed on one side of the plasma display panel 20 and is also electrically connected to sustain electrodes through a cable 1120 such as a Flexible Printed Circuit (FPC).

This conventional plasma display apparatus must have the cable 1120 having a long length. If the length of the cable 1120 is long, a path along which the driving pulse is applied becomes long and noise is likely to occur. Accordingly, there is a problem in that a driving pulse applied through the cable 1120 is distorted. In addition, if the length of the cable 1120 becomes long, there is a problem in that the manufacturing cost is increased.

### SUMMARY OF THE INVENTION

Accordingly, the present invention has been made in view of the above problems, and it is an object of the present invention to provide a plasma display apparatus in which the manufacturing cost due to driving boards and the area occupied by the driving boards can be reduced.

Another object of the present invention is to provide a plasma display apparatus in which a path along which driving pulses are applied can be shortened.

To achieve the above objects, a plasma display apparatus according to the present invention includes a glass substrate having scan electrodes and sustain electrodes formed therein, an integrated electrode driving unit for generating a first driving pulse and a second driving pulse to drive the scan electrodes and the sustain electrodes, and an electrode pad formed at one side of the glass substrate, for applying the first driving pulse and the second driving pulse to the scan electrodes and the sustain electrodes, respectively.

The electrode pad may be plural in number, and one electrode pad can apply the first driving pulse and the second driving pulse to some of the scan electrodes and the sustain electrodes.

The electrode pad may be one in number, and the one electrode pad can apply the first driving pulse and the second driving pulse to the entire scan electrodes and the entire sustain electrodes.

The sustain electrodes may have one end electrically connected to the electrode pad and the other end electrically commonly connected.

Some of the sustain electrodes may have one end electrically connected to the electrode pad and the other end electrically commonly connected.

The sustain electrodes may have one end electrically connected to the electrode pad and the other end electrically commonly connected. The electrode pad may be plural in number. One electrode pad may apply the first driving pulse and the second driving pulse to some of the scan electrodes and the sustain electrodes.

The sustain electrodes may have one end electrically connected to the electrode pad and the other end electrically commonly connected. The electrode pad may be one in number. The one electrode pad may apply the first driving pulse and the second driving pulse to the entire scan electrodes and the entire sustain electrodes.

Some of the sustain electrodes have one end electrically connected to the electrode pad and the other end electrically commonly connected. The electrode pad may be plural in number. One electrode pad applies the first driving pulse and the second driving pulse to some of the scan electrodes and the sustain electrodes.

Some of the sustain electrodes may have one end electrically connected to the electrode pad and the other end electrically commonly connected. The electrode pad may be one in number. The one electrode pad may apply the first driving pulse and the second driving pulse to the entire scan electrodes and the entire sustain electrodes.

A plasma display panel according to the present invention includes a glass substrate having scan electrodes and sustain electrodes formed therein, and an electrode pad formed at one side of the glass substrate, for applying externally input first driving pulse and second driving pulse to the scan electrodes and the sustain electrodes, respectively.

The electrode pad may be plural in number, and one electrode pad can apply the first driving pulse and the second driving pulse to some of the scan electrodes and the sustain electrodes.

The electrode pad may be one in number, and the one electrode pad can apply the first driving pulse and the second driving pulse to the entire scan electrodes and the entire sustain electrodes.

The sustain electrodes may have one end electrically connected to the electrode pad and the other end electrically commonly connected.

Some of the sustain electrodes may have one end electrically connected to the electrode pad and the other end electrically commonly connected.

The sustain electrodes may have one end electrically connected to the electrode pad and the other end electrically commonly connected. The electrode pad may be plural in number. One electrode pad may apply the first driving pulse the second driving pulse to some of the scan electrodes and the sustain electrodes.

The sustain electrodes may have one end electrically connected to the electrode pad and the other end electrically commonly connected. The electrode pad may be one in number. The one electrode pad may apply the first driving pulse and the second driving pulse to the entire scan electrodes and the entire sustain electrodes.

Some of the sustain electrodes have one end electrically connected to the electrode pad and the other end electrically commonly connected. The electrode pad may be plural in number. One electrode pad applies the first driving pulse and the second driving pulse to some of the scan electrodes and the sustain electrodes.

Some of the sustain electrodes may have one end electrically connected to the electrode pad and the other end electrically commonly connected. The electrode pad may be one in number. The one electrode pad may apply the first driving pulse and the second driving pulse to the entire scan electrodes and the entire sustain electrodes.

### BRIEF DESCRIPTION OF THE DRAWINGS

Further objects and advantages of the invention can be more fully understood from the following detailed description taken in conjunction with the accompanying drawings in which:

FIG. 1 shows the panel structure of a general plasma display apparatus;

FIG. 2 shows a conventional plasma display apparatus;

FIG. 3 shows an exemplary arrangement of each driving board attached on a frame of the conventional plasma display apparatus;

FIG. 4 shows another conventional plasma display apparatus;

FIG. 5 shows another exemplary arrangement of each driving board attached on a frame of the conventional plasma display apparatus;

FIG. 6a shows an embodiment of a plasma display panel according to the present invention;

FIG. 6b shows another embodiment of a plasma display panel according to the present invention;

FIG. 7a shows an embodiment of a plasma display apparatus according to the present invention;

FIG. 7b shows another embodiment of a plasma display apparatus according to the present invention;

FIG. 8 shows an exemplary arrangement of each driving board attached on a frame of the plasma display apparatus according to the present invention;

FIG. 9a shows an embodiment of the connection relation of sustain electrodes formed in the plasma display panel according to the present invention;

FIG. 9b shows an embodiment of a plasma display apparatus constructed using the plasma display panel in which sustain electrodes that are connected according to an embodiment of FIG. 9a are formed;

FIG. 9c shows another embodiment of a plasma display apparatus constructed using the plasma display panel in which sustain electrodes that are connected according to an embodiment of FIG. 9a are formed;

FIG. 10a shows another embodiment of the connection relation of sustain electrodes formed in the plasma display panel according to the present invention;

FIG. 10b shows an embodiment of a plasma display apparatus constructed using the plasma display panel in which sustain electrodes that are connected according to an embodiment of FIG. 10a are formed; and

FIG. 10c shows another embodiment of a plasma display apparatus constructed using the plasma display panel in which sustain electrodes that are connected according to an embodiment of FIG. 10a are formed.

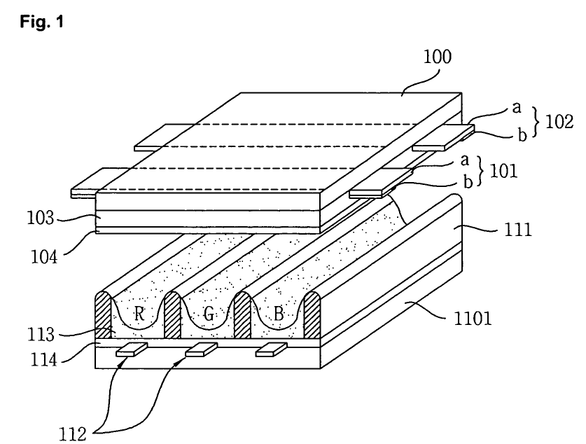

### DETAILED DESCRIPTION OF THE PREFERRED EMBODIMENT

The present invention will now be described in detail in connection with preferred embodiments with reference to the accompanying drawings.

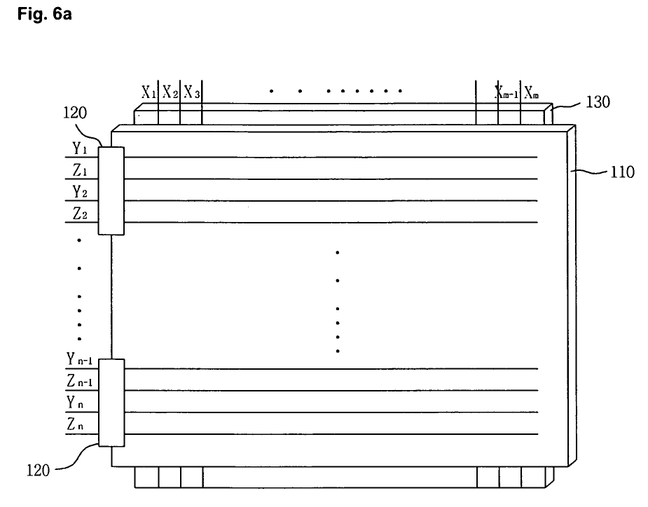

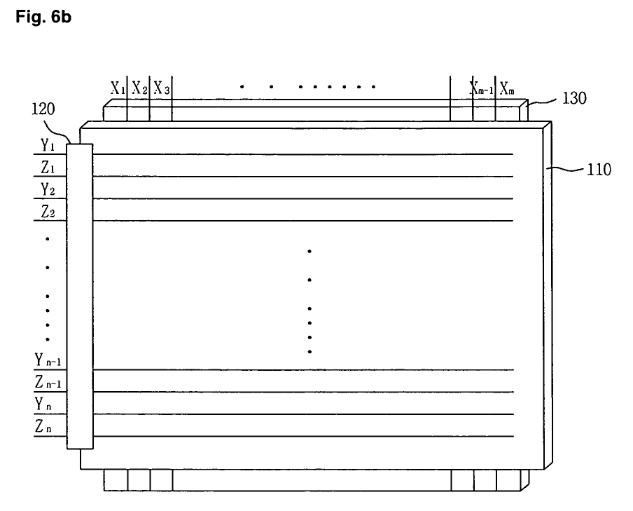

FIG. 6a shows an embodiment of a plasma display panel according to the present invention. As shown in FIG. 6a, the plasma display panel according to the present invention includes an upper glass substrate 110, electrode pads 120 and a lower glass substrate 130.

Scan electrodes Y1 to Yn and sustain electrodes Z1 to Zn are formed in the upper glass substrate 110.

The electrode pads 120 are formed on one side of the upper glass substrate 110 and apply externally input first driving pulse and second driving pulse to the scan electrodes Y1 to Yn and the sustain electrodes Z1 to Zn, respectively. The first driving pulse can be a ramp pulse, a scan pulse or a sustain pulse, and is a pulse for driving the scan electrodes. The second driving pulse can be a sustain pulse applied alternately with the sustain pulse applied to the scan electrodes, and is a pulse for driving the sustain electrodes. At this time, one electrode pad 120 applies the first driving pulse and the second driving pulse to some of the entire scan electrodes and the entire sustain electrodes. Furthermore, one electrode pad 120 can apply the first driving pulse and the second driving pulse to the entire scan electrodes and the entire sustain electrodes, as shown in FIG. 6b.

The lower glass substrate 130 is disposed parallel to a rear surface of the glass substrate 110. In the lower glass substrate 130 are formed address electrodes X1 to Xm.

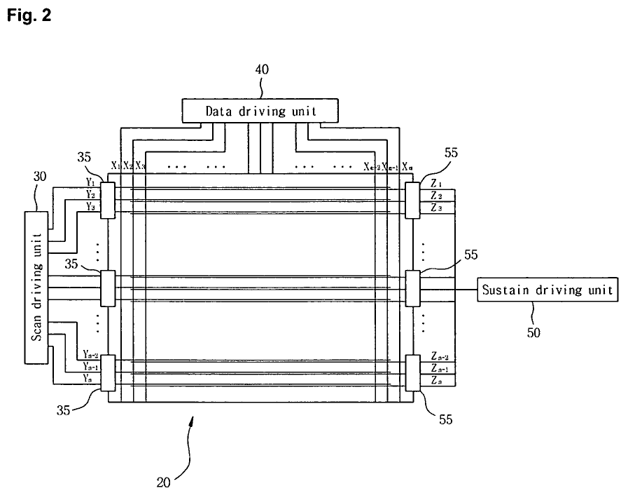

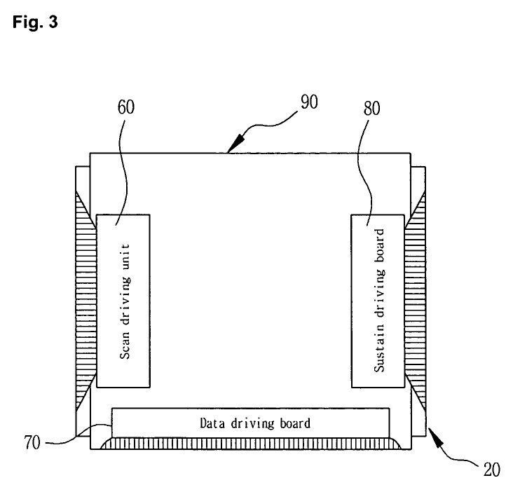

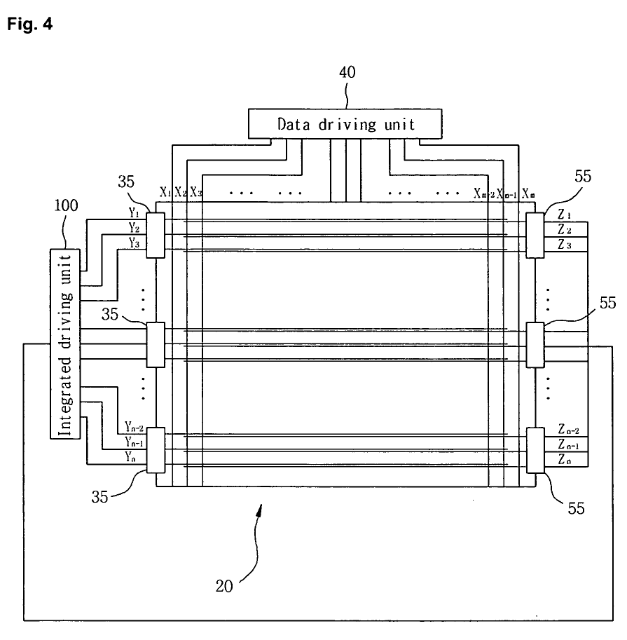

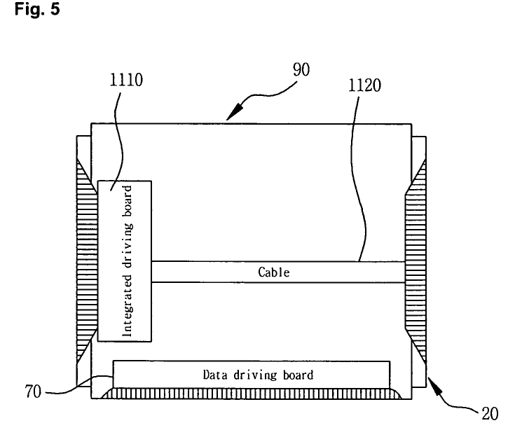

In the plasma display panel constructed above according to the present invention, the electrode pads 120 are formed on one side of the upper glass substrate 110 unlike the conventional plasma display apparatus shown in FIG. 2 or 4.

Accordingly, the directions in which the first driving pulse and the second driving pulse are applied are the same. For example, if the electrode pads 120 are formed on the left side of the upper glass substrate 110 as shown in FIG. 6, the first driving pulse and the second driving pulse are input to the left side.

Accordingly, in the plasma display panel according to the present invention, not only the scan electrodes and the sustain electrodes can be driven through one driving unit, but also there is no need for a cable for driving the sustain electrodes.

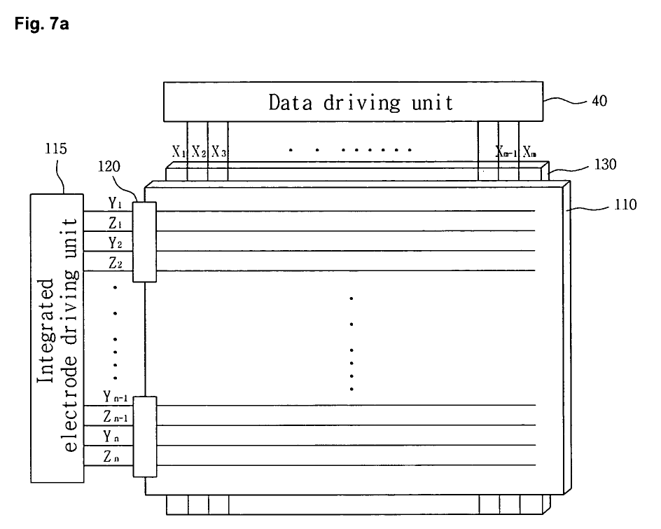

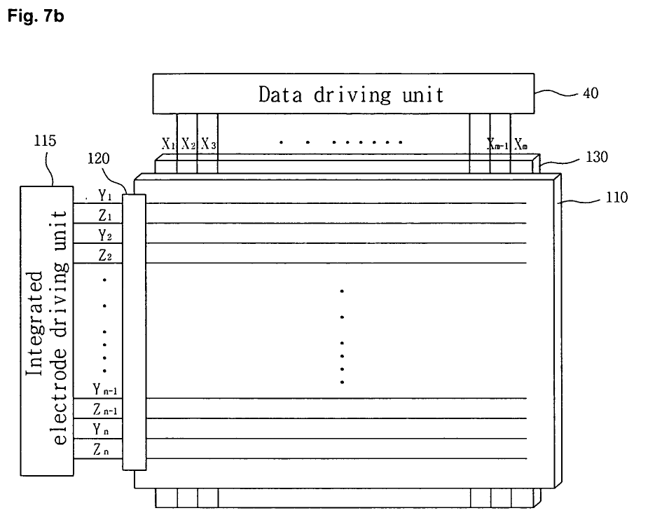

FIG. 7 shows an embodiment of a plasma display apparatus according to the present invention. As shown in FIG. 7, the plasma display apparatus according to the present invention includes an upper glass substrate 110, an integrated electrode driving unit 115, an electrode pads 120, a lower glass substrate 130 and a data driving unit 40.

Scan electrodes Y1 to Yn and sustain electrodes Z1 to Zn are formed in the upper glass substrate 110.

The integrated electrode driving unit 115 generates a first driving pulse and a second driving pulse for driving the scan electrodes and the sustain electrode, respectively.

The electrode pads 120 are formed on one side of the upper glass substrate 110 and apply the first driving pulse and the second driving pulse, which are received from the integrated electrode driving unit 115, to the scan electrodes Y1 to Yn and the sustain electrodes Z1 to Zn, respectively. At this time, one electrode pad 120 applies the first driving pulse and the second driving pulse to some of the entire scan electrodes and the entire sustain electrodes. Furthermore, one electrode pad 120 can apply the first driving pulse and the second driving pulse to the entire scan electrodes and the entire sustain electrodes, as shown in FIG. 7b.

The lower glass substrate 130 is disposed on a rear surface of the glass substrate 110 parallel to it. In the lower glass substrate 130 are formed address electrodes X1 to Xm.

The data driving unit 40 applies an address pulse to the address electrodes X1 to Xm.

In the plasma display apparatus constructed above according to the present invention, the electrode pads 120 are formed on one side of the upper glass substrate 110 unlike the conventional plasma display apparatus shown in FIG. 2 or FIG. 4. Accordingly, not only the integrated electrode driving unit 115 can drive the scan electrodes Y1 to Yn and the sustain electrodes Z1 to Zn, but also there is no need for a cable for driving the sustain electrodes Z1 to Zn.

The integrated electrode driving unit 115 and the data driving unit 40 can be formed in the form of a driving board. Each driving board is formed on a frame attached to a rear surface of the plasma display panel.

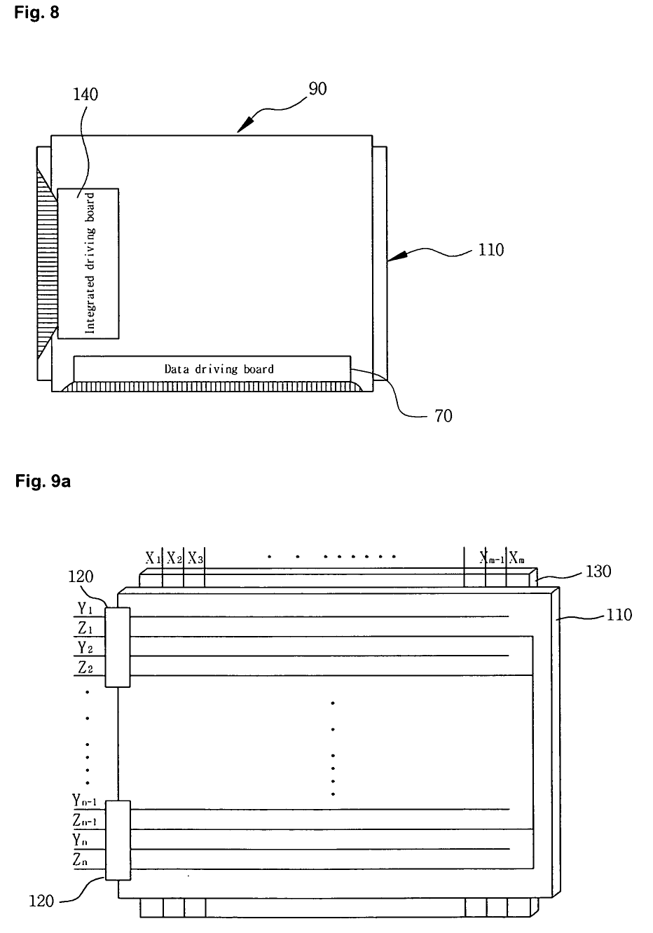

FIG. 8 shows an exemplary arrangement of each driving board attached on a frame of the plasma display apparatus according to the present invention.

As shown in FIG. 8, an integrated electrode driving board 140 and a data driving board 70 are attached on a frame 90. The integrated electrode driving board 140 is one that has implemented the integrated electrode driving unit 115 of FIG. 7.

The integrated electrode driving board 115 is attached to one side of the frame 90 and is electrically connected to the scan electrodes and the sustain electrodes of the plasma display panel 20 through the electrode pads 120 of FIG. 7. The integrated electrode driving board 115 applies the first driving pulse and the second driving pulse to the scan electrodes and the sustain electrodes, respectively. For example, the integrated electrode driving board 115 can apply a sustain pulse, which is alternated after the sustain pulse is applied to the scan electrodes through the electrode pads 120 of FIG. 7, to the sustain electrodes through the electrode pads 120 of FIG. 7.

Therefore, the plasma display apparatus according to the present invention can drive all the scan electrodes and the sustain electrodes through the electrode pads and one driving board formed on one side of the plasma display panel. Accordingly, the manufacturing cost can be reduced and the area occupied by the driving board can be reduced. In addition, since there is no need for a cable to drive sustain electrodes, the manufacturing cost can be reduced and a driving pulse can be applied exactly.

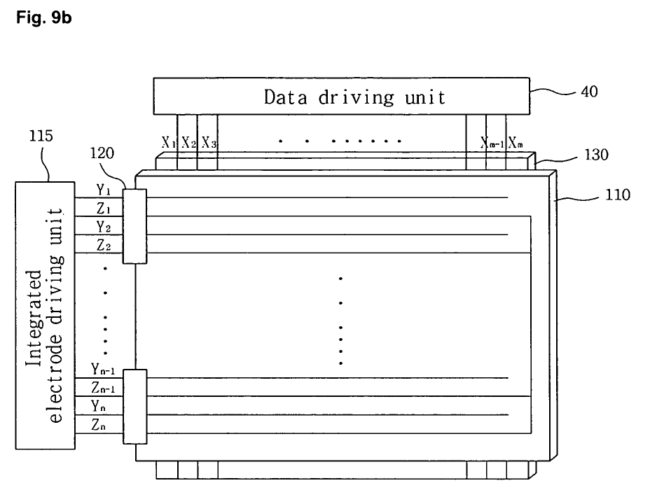

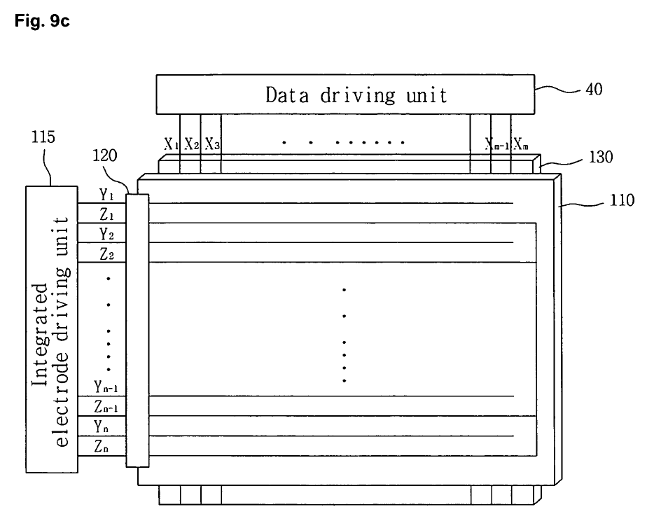

FIG. 9a shows an embodiment of the connection relation between sustain electrodes formed in a plasma display panel according to the present invention.

As shown in FIG. 9a, electrode pads 120 are formed on one side of the upper glass substrate 110 and apply externally input first driving pulse and second driving pulse to scan electrodes Y1 to Yn and sustain electrodes Z1 to Zn, respectively. At this time, the entire sustain electrodes Z1 to Zn are commonly connected. Accordingly, the entire sustain electrodes Z1 to Zn haven an equivalent potential. Therefore, more accurate electrode driving is possible compared to when the second driving pulse is applied to the entire sustain electrodes Z1 to Zn through the electrode pads 120 formed on one side of the plasma display panel.

The plasma display apparatus shown in FIG. 9b can be implemented using the plasma display panel in which the sustain electrodes connected are formed. At this time, one electrode pad 120 applies the first driving pulse and the second driving pulse to some of the entire scan electrodes and the entire sustain electrodes.

Further, the plasma display apparatus shown in FIG. 9c can be implemented using the plasma display panel in which the sustain electrodes connected are formed. At this time, one electrode pad 120 applies the first driving pulse and the second driving pulse to the entire scan electrodes and the entire sustain electrodes.

The operation of each of the integrated electrode driving unit 115 and the data driving unit 40 is the same as that described above. Description thereof will be omitted.

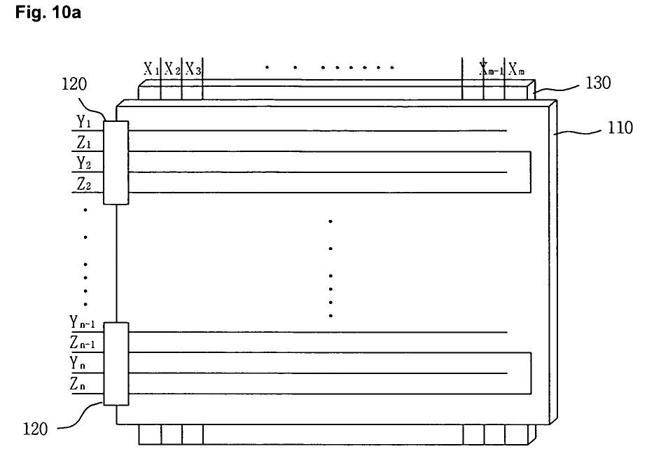

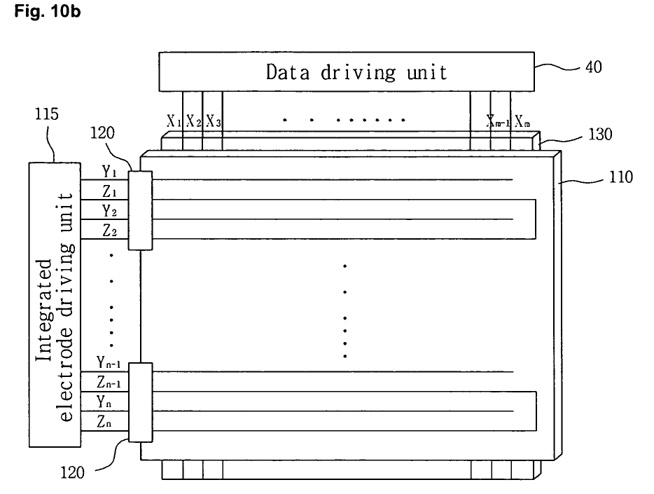

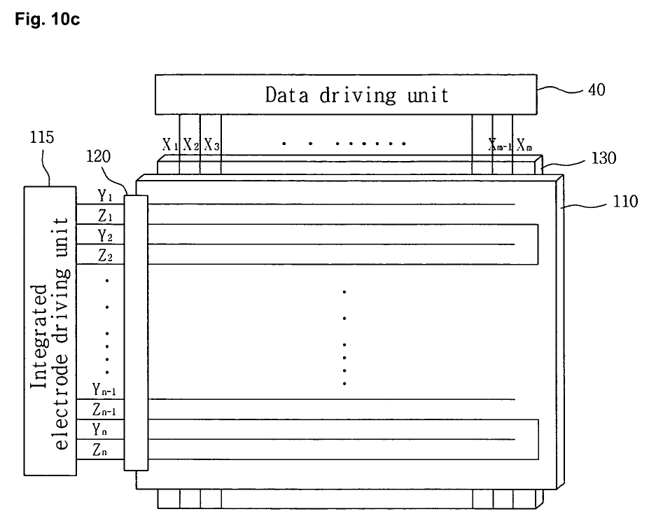

FIG. 10a shows another embodiment of the connection relation of sustain electrodes formed in the plasma display panel according to the present invention.

As shown in FIG. 10a, electrode pads 120 are formed on one side of the upper glass substrate 110 and apply externally input first driving pulse and second driving pulse to scan electrodes Y1 to Yn and sustain electrodes Z1 to Zn, respectively. At this time, some of the entire sustain electrodes Z1 to Zn are commonly connected. Accordingly, some sustain electrodes that are commonly connected haven an equivalent potential. Therefore, more accurate electrode driving is possible compared to when the second driving pulse is applied to the entire sustain electrodes Z1 to Zn through the electrode pads 120 formed on one side of the plasma display panel.

The plasma display apparatus shown in FIG. 10b can be implemented using the plasma display panel in which the sustain electrodes connected are formed. At this time, one electrode pad 120 applies the first driving pulse and the second driving pulse to some of the entire scan electrodes and the entire sustain electrodes.

Further, the plasma display apparatus shown in FIG. 10c can be implemented using the plasma display panel in which the sustain electrodes connected are formed. At this time, one electrode pad 120 applies the first driving pulse and the second driving pulse to the entire scan electrodes and the entire sustain electrodes.

The operation of each of the integrated electrode driving unit 115 and the data driving unit 40 is the same as that described above. Description thereof will be omitted.

As described above, according to a plasma display apparatus in accordance with the present invention, driving pulses are applied to scan electrodes and sustain electrodes through electrode pads formed at one side. Therefore, the manufacturing cost and the area of driving boards can be reduced.

According to a plasma display apparatus in accordance with the present invention, driving pulses are applied to scan electrodes and sustain electrodes through electrode pads formed at one side. Accordingly, the application path of the driving pulses can be shortened and the manufacturing cost can be saved.

According to a plasma display apparatus in accordance with the present invention, driving pulses are applied to scan electrodes and sustain electrodes through electrode pads formed at one side. Accordingly, the application path of the driving pulses can be shortened and the driving pulses can be correctly applied.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display apparatus, comprising:
a glass substrate having scan electrodes and sustain electrodes formed therein;
an integrated electrode driving unit for generating a first driving pulse and a second driving pulse to drive the scan electrodes and the sustain electrodes; and
an electrode pad formed at one side of the glass substrate, for applying the first driving pulse and the second driving pulse to the scan electrodes and the sustain electrodes, respectively.

2. The plasma display apparatus as claimed in claim 1, wherein the electrode pad is plural in number, and one electrode pad applies the first driving pulse and the second driving pulse to some of the scan electrodes and the sustain electrodes.

3. The plasma display apparatus as claimed in claim 1, wherein the electrode pad is one in number, and the one electrode pad applies the first driving pulse and the second driving pulse to the entire scan electrodes and the entire sustain electrodes.

4. The plasma display apparatus as claimed in claim 1, wherein the sustain electrodes is electrically connected at one end to the electrode pad and is electrically commonly connected at the other end.

5. The plasma display apparatus as claimed in claim 1, wherein some of the sustain electrodes are electrically connected at one end to the electrode pad and are electrically commonly connected at the other end.

6. The plasma display apparatus as claimed in claim 1, wherein the sustain electrodes electrically connected at one end to the electrode pad and electrically commonly connected at the other end,
the electrode pad is plural in number, and
one electrode pad applies the first driving pulse and the second driving pulse to some of the scan electrodes and the sustain electrodes.

7. The plasma display apparatus as claimed in claim 1, wherein the sustain electrodes are electrically connected at one end to the electrode pad and are electrically commonly connected at the other end,
the electrode pad is one in number, and
the one electrode pad applies the first driving pulse and the second driving pulse to the entire scan electrodes and the entire sustain electrodes.

8. The plasma display apparatus as claimed in claim 1, wherein some of the sustain electrodes are electrically connected at one end to the electrode pad and electrically commonly connected at the other end,
the electrode pad is plural in number, and
one electrode pad applies the first driving pulse and the second driving pulse to some of the scan electrodes and the sustain electrodes.

9. The plasma display apparatus as claimed in claim 1, wherein some of the sustain electrodes are electrically connected at one end to the electrode pad and electrically commonly connected at the other end,
the electrode pad is one in number, and
the one electrode pad applies the first driving pulse and the second driving pulse to the entire scan electrodes and the entire sustain electrodes.

10. A plasma display panel, comprising:
a glass substrate having scan electrodes and sustain electrodes formed therein; and
an electrode pad formed at one side of the glass substrate, for applying externally input first driving pulse and second driving pulse to the scan electrodes and the sustain electrodes, respectively.

11. The plasma display panel as claimed in claim 10, wherein the electrode pad is plural in number, and one electrode pad applies the first driving pulse and the second driving pulse to some of the scan electrodes and the sustain electrodes.

12. The plasma display panel as claimed in claim 10, wherein the electrode pad is one in number, and the one electrode pad applies the first driving pulse and the second driving pulse to the entire scan electrodes and the entire sustain electrodes.

13. The plasma display panel as claimed in claim 10, wherein the sustain electrodes are electrically connected at one end to the electrode pad and electrically commonly connected at the other end.

14. The plasma display panel as claimed in claim 10, wherein some of the sustain electrodes are electrically connected at one end to the electrode pad and electrically commonly connected at the other end.

15. The plasma display panel as claimed in claim 10, wherein the sustain electrodes are electrically connected at one end to the electrode pad and electrically commonly connected at the other end,
the electrode pad is plural in number, and
one electrode pad applies the first driving pulse and the second driving pulse to some of the scan electrodes and the sustain electrodes.

16. The plasma display panel as claimed in claim 10, wherein the sustain electrodes are electrically connected at one end to the electrode pad and electrically commonly connected at the other end,
the electrode pad is one in number, and
the one electrode pad applies the first driving pulse and the second driving pulse to the entire scan electrodes and the entire sustain electrodes.

17. The plasma display panel as claimed in claim 10, wherein some of the sustain electrodes are electrically connected at one end to the electrode pad and electrically commonly connected at the other end,
the electrode pad is plural in number, and
one electrode pad applies the first driving pulse and the second driving pulse to some of the scan electrodes and the sustain electrodes.

18. The plasma display panel as claimed in claim 10, wherein some of the sustain electrodes are electrically connected at one end to the electrode pad and electrically commonly connected at the other end,
the electrode pad is one in number, and
the one electrode pad applies the first driving pulse and the second driving pulse to the entire scan electrodes and the entire sustain electrodes.
